(19) United States
(12) Patent Application Publication
(10) Pub. No.: US 2015/0340790 A1
(43) Pub. Date: Nov. 26, 2015

(54) JOINT CONNECTOR

(71) Applicant: Yazaki Corporation, Minato-ku, Tokyo (JP)

(72) Inventors: Tsuyoshi HAMAI, Shizuoka (JP); Takashi MURO, Shizuoka (JP); Tomihiko NAGAYOSHI, Shizuoka (JP)

(21) Appl. No.: 14/353,094

(22) PCT Filed: Oct. 30, 2012
(86) PCT No.: PCT/JP2012/006942

§ 371 Date: Apr. 21, 2014

(30) Foreign Application Priority Data
Nov. 9, 2011 (JP) 2011-245255

(51) Int. Cl. H01R 13/42

(52) U.S. Cl. CPC H01R 13/42

(57) ABSTRACT

A joint connector includes a connector housing having terminal accommodation chambers configured to accommodate terminal fittings and having elastically-deformable locking lances configured to engage with the corresponding terminal fittings, bus bars configured to connect the terminal fittings to each other, and a front holder to be installed in the connector housing from an opposite side to a side where the terminal fittings are inserted. The front holder has a holder main body integrated with the bus bars and lance deformation prevention portions configured to prevent elastic deformation of the locking lances. In an engagement state of the terminal fittings and the locking lances, the lance deformation prevention portions are configured to be inserted into spaces in which the locking lances are deflected.

### TECHNICAL FIELD

The present invention relates to a joint connector including a connector housing provided with a plurality of terminal accommodation chambers in which a plurality of terminal fittings is accommodated, and bus bars for connecting the plurality of terminal fittings.

### BACKGROUND ART

In general, in a joint connector, a plurality of terminal fittings attached to terminals of electric wires is respectively accommodated in a plurality of terminal accommodation chambers formed in a connector housing. The terminal fittings accommodated in the terminal accommodation chambers are connected by bus bars.

Such terminal fittings are proposed in Patent Literature 1, and locking convex portions to be inserted into lock holes formed in the bus bars are provided. Accordingly, the terminal fittings are prevented from being drawn out from the terminal accommodation chambers.

### CITATION LIST

### Patent Literature

[PTL 1] JP 11-329569 A

### SUMMARY OF INVENTION

However, in the above joint connector, the locking convex portions are only simply inserted into the lock holes of the bus bars. Thus, contact between the terminal fittings and the bus bars is sometimes cancelled by some impact (such as vibration of a vehicle). Therefore, there is still room for improving a retaining force of the terminal fittings in the connector housing.

In the above joint connector, it is difficult to determine whether or not the terminal fittings are completely installed in the terminal accommodation chambers (whether or not the locking convex portions are engaged with the lock holes), and an installment state of the terminal fittings into the terminal accommodation chambers (including a half-installment state) cannot be detected.

An object of the present invention is to provide a joint connector capable of detecting an installment state of terminal fittings into terminal accommodation chambers while improving a retaining force of the terminal fittings in a connector housing.

A joint connector in accordance with some embodiments includes a connector housing having terminal accommodation chambers configured to accommodate terminal fittings therein, the terminal accommodation chambers having elastically-deformable locking lances configured to engage with the corresponding terminal fittings, bus bars configured to connect the terminal fittings to each other, and a front holder to be installed in the connector housing from an opposite side to a side where the terminal fittings are inserted, the front holder having a holder main body integrated with the bus bars and lance deformation prevention portions integrated with the holder main body, the lance deformation prevention portions being configured to prevent elastic deformation of the locking lances. In an engagement state of the terminal fittings and the locking lances, the lance deformation prevention portions are configured to be inserted into spaces in which the locking lances are deflected.

With the above configuration, the lance deformation prevention portions prevent the electric deformation of the locking lances. Accordingly, even in a case where some impact (such as vibration of a vehicle) is generated, the locking lances engaged with the terminal fittings are not elastically deformed, so that disengagement of the terminal fittings and the locking lances can be prevented. Therefore, the retaining force of the terminal fittings in the connector housing can be improved.

The lance deformation prevention portions are inserted into the spaces in which the locking lances are deflected in the engagement state of the terminal fittings and the locking lances. Accordingly, the front holder is installed in the connector housing, so that the engagement state of the terminal fittings and the locking lances can be detected. Thus, the fact that the terminal fittings are completely installed in the terminal accommodation chamber can be detected. Meanwhile, the lance deformation prevention portions are abutted with the locking lances in a non-engagement state of the terminal fittings and the locking lances. Accordingly, the front holder is not installed in the connector housing, so that the non-engagement state of the terminal fittings and the locking lances can be detected. Thus, the fact that the terminal fittings are not installed in the terminal accommodation chamber can be detected. As a result, an installment state of the terminal fittings into the terminal accommodation chambers (including a half-installment state) can be detected.

Further, the bus bars and the lance deformation prevention portions are integrated with the holder main body. Accordingly, in comparison to a case where the bus bars and the lance deformation prevention portions are separate bodies, an assembling task can be reduced and manufacturing cost of the joint connector can be reduced.

The connector housing may include a holder accommodation chamber configured to accommodate the front holder therein, and the front holder may include a packing closely attached to an inner surface of the holder accommodation chamber and an outer surface of the holder main body.

With the above configuration, the packing is closely attached to the inner surface of the holder accommodation chamber and the outer surface of the holder main body. Accordingly, water and the like can be prevented from coming into the connector housing.

The holder main body may include an engaged portion configured to be engaged with an engagement portion provided on an outer surface of the connector housing to fix the front holder to the connector housing.

With the above configuration, the engaged portion is engaged with the engagement portion. Accordingly, the front holder is fixed to the connector housing and the front holder can be prevented from being detached from the connector housing.

### BRIEF DESCRIPTION OF DRAWINGS

FIG. 1 is a perspective view showing a fitting state of a joint connector according to an embodiment of the present invention.

FIG. 2 is an exploded perspective view showing the joint connector according to the embodiment.

FIG. 3 is an exploded perspective view showing the joint connector according to the embodiment.

FIG. 4 is a sectional view showing the joint connector according to the embodiment.

FIG. 5 is a sectional view showing the joint connector according to the embodiment.

FIG. 6 is a sectional view showing the joint connector according to the embodiment.

FIG. 7 (a) is a sectional view showing the joint connector according to the embodiment, and FIG. 7 (b) is an enlarged view showing inside of Frame A of FIG. 7(a).

### DESCRIPTION OF EMBODIMENTS

A joint connector according to an embodiment of the present invention will be described with reference to the drawings. Specifically, (1) a configuration of the joint connector, (2) a configuration of a front holder, (3) an installment method of the front holder, (4) operations and effects, and (5) other embodiments will be described.

It should be noted that in the following description of the figures, the same or similar parts will be given the same or similar reference signs. However, note that the figures are schematic ones and ratios and the like in terms of size are different from reality.

Therefore, specific size and the like should be determined in consideration with the following description. Relationships or ratios in terms of size can be different between the figures.

### (1) Configuration of Joint Connector

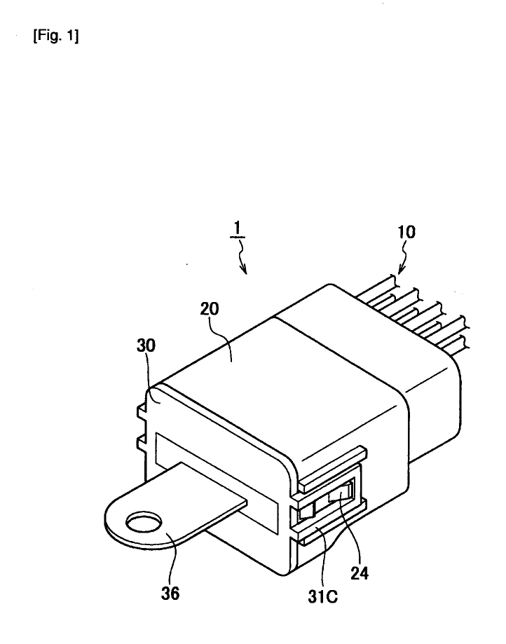

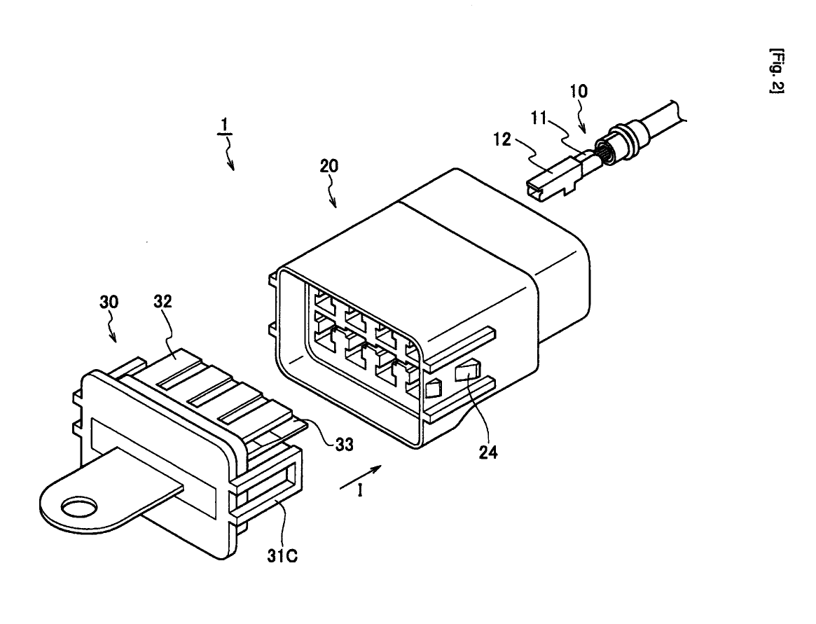

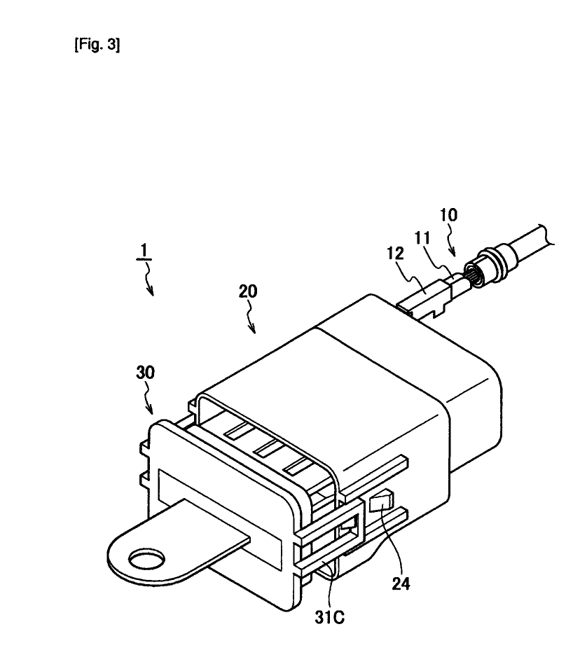

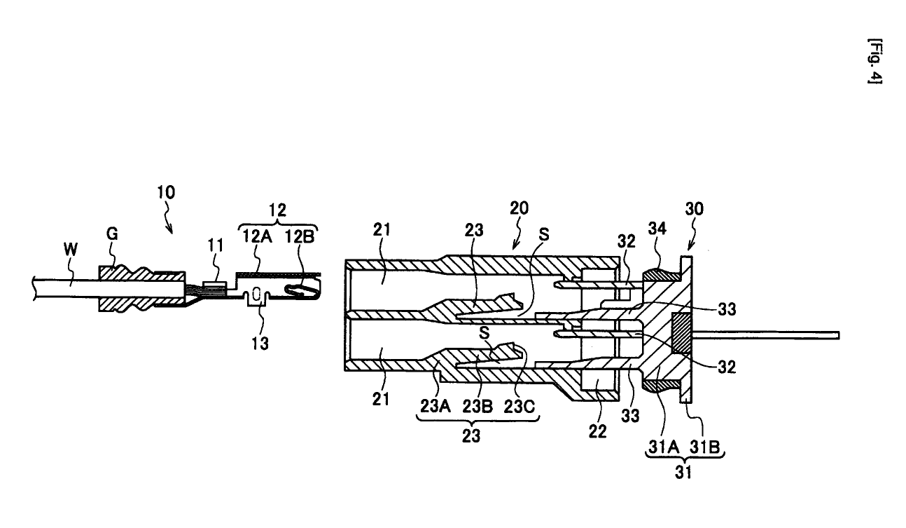

A configuration of a joint connector 1 according to the present embodiment will be described with reference to the drawings. FIG. 1 is a perspective view showing the joint connector 1 according to the present embodiment. FIGS. 2 and 3 are exploded perspective views showing the joint connector 1 according to the present embodiment. FIGS. 4 to 6 are sectional views showing the joint connector 1 according to the present embodiment.

As shown in FIGS. 1 to 6, the joint connector 1 includes a plurality of terminal fittings 10 to which electric wires W are connected, a connector housing 20 in which the plurality of terminal fittings 10 is installed, and a front holder 30 installed in the connector housing 20 from the opposite side to the side where the plurality of terminal fittings 10 is inserted.

The electric wire W is formed by a core wire and a coating material for coating the core wire. A rubber stopper G (refer to FIGS. 4 to 6) for preventing water and the like from coming into the connector housing 20 is provided in a terminal of this electric wire W (in an end in which the terminal fitting 10 is installed). The terminal fitting 10 is attached to an outer periphery of this rubber stopper G.

The terminal fitting 10 includes a caulking portion 11 to which the electric wire W is caulked and fixed, and a contact portion 12 positioned on the front side of the caulking portion 11 and brought into contact with a bus bar 32 described later. As shown in FIG. 4, this contact portion 12 includes a box shape front end part 12A and an elastically-deformable contact piece 12B provided in the front end part 12A. A lance insertion hole (refer to FIG. 4) into which a locking lance 23 in the connector housing 20 is inserted is formed in the front end part 12A.

In the connector housing 20, a plurality of terminal accommodation chambers 21 in which the plurality of terminal fittings 10 is accommodated, and a holder accommodation chamber 22 in which the front holder 30 is accommodated. In this terminal accommodation chamber 21, the locking lance 23 (refer to FIGS. 4 to 6) cantilevered on a surface along the insertion direction in which the plurality of terminal fittings 10 is inserted into the terminal accommodation chambers 21 (on a lower surface in the present embodiment) is provided.

The locking lance 23 is engaged with the lance insertion hole 13 of the terminal fitting 10 and formed to be elastically deformable. As shown in FIG. 4, this locking lance 23 includes a fixing end 23A fixed to the lower surface of the terminal accommodation chamber 21, an arm 23B cantilevered from the fixing end 23A, and a locking projection end 23C (refer to FIGS. 1 to 3) provided in a front end of the arm 23B and formed to be insertable into the lance insertion hole 13 of the terminal fitting 10. Between such a locking lance 23 (the arm 23B and the locking projection end 23C) and the lower surface of the terminal accommodation chamber 21, a space S in which the locking lance 23 can be deformed to deflect is formed.

On an outer surface (a side wall in the present embodiment) of the connector housing 20, an engagement convex portion (an engagement portion) 24 (refer to FIGS. 1 to 3) protruding outward is provided.

### (2) Configuration of Front Holder

A detail of the front holder 30 described above will be described with reference to FIGS. 2 to 6.

As shown in FIGS. 2 to 6, the front holder 30 includes a holder main body 31, the bus bars 32 integrated with the holder main body 31, lance deformation prevention portions 33, and a packing 34.

The holder main body 31 is installed in the holder accommodation chamber 22. Specifically, the holder main body 31 is made of resin or the like. As shown in FIG. 4, this holder main body 31 includes an insertion portion 31A inserted into the holder accommodation chamber 22, a flange portion 31B abutted with an opening end of the holder accommodation chamber 22 and extended from the holder main body 31, and an engaged frame (an engaged portion) 31C (refer to FIGS. 1 to 3) engaged with the engagement convex portion 24 of the connector housing 20.

The bus bar 32 is to connect the plurality of terminal fittings 10. The bus bar 32 is inserted into the terminal accommodation chamber 21 so as to be brought into contact with the contact piece 12B in the contact portion 12 of the terminal fitting 10. Specifically, the bus bar 32 is formed by a metal plate member or the like. This bus bar 32 is provided on a front side surface of the insertion portion 31A of the holder main body 31 in the insertion direction I to the connector housing 20 and protrudes along the insertion direction I from the front side surface. The bus bar 32 is provided in substantially parallel to the lance deformation prevention portion 33 in a sectional view of the joint connector 1.

The lance deformation prevention portion 33 is to prevent elastic deformation of the locking lance 23. In an engagement state of the lance insertion hole 13 of the terminal fitting 10 and the locking projection end 23C of the locking lance 23, the lance deformation prevention portion 33 is inserted into the space S in which the locking lance 23 is deflected, so as to be brought into contact with the arm 23B of the locking lance 23. Specifically, the lance deformation prevention portion 33 is made of resin or the like as well as the holder main body 31. This lance deformation prevention portion 33 is provided on the front side surface of the insertion portion 31A of the holder main body 31 in the insertion direction I and protrudes along the insertion direction from the front side surface.

The packing 34 is to prevent water and the like from coming into the connector housing 20. The packing 34 is closely attached to an inner surface of the holder accommodation chamber 22 and an outer surface of the insertion portion 31A of the holder main body 31. This packing 34 is formed by a rubber member or the like.

### (3) Installment Method of Front Holder

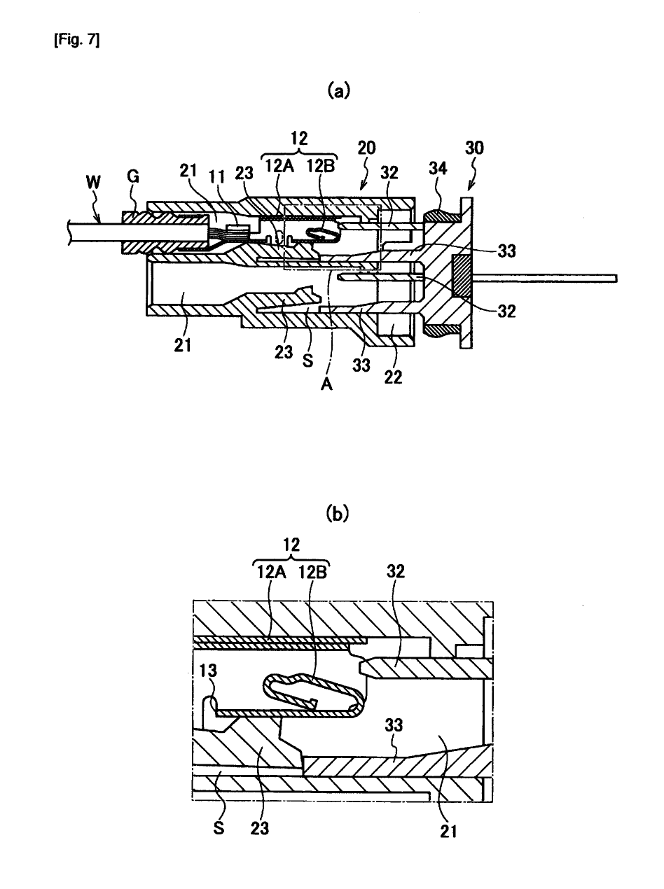

The installment method of the front holder 30 described above will be described with reference to FIGS. 4 to 7. It should be noted that FIG. 7 is a sectional view of the joint connector 1 according to the present embodiment, the view showing a half-engagement state of the front holder 30 and the connector housing 20.

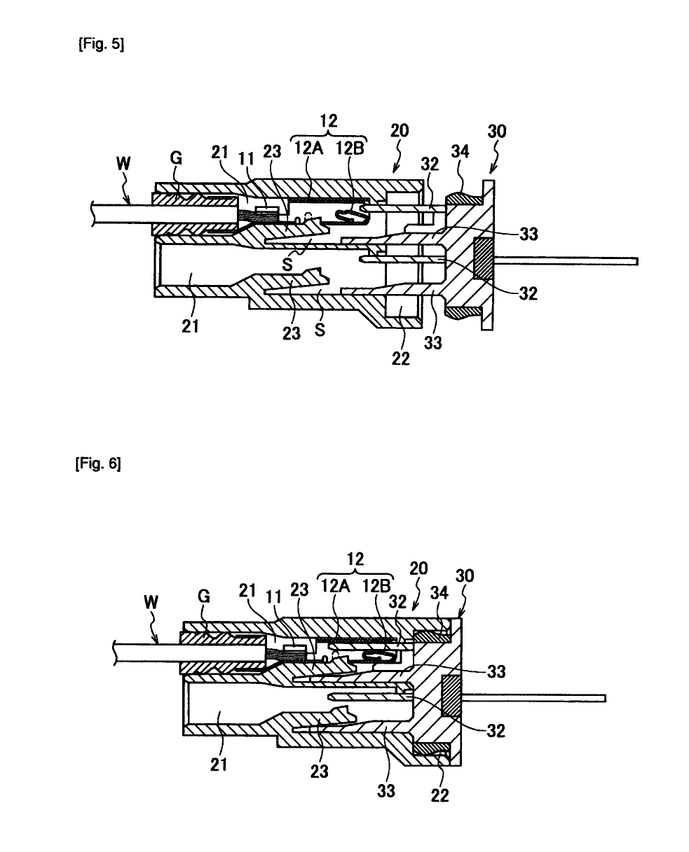

Firstly, as shown in FIGS. 4 and 5, the terminal fitting 10 is gradually inserted into the connector housing 20. Then, as shown in FIG. 5, when the terminal fitting 10 is completely installed in the connector housing 20, the locking projection end 23C of the locking lance 23 is inserted into the lance insertion hole 13 of the terminal fitting 10. At this time, the rubber stopper G attached to the terminal of the electric wire W is closely attached to the outer periphery of the electric wire W (the coating material) and an inner surface of the terminal accommodation chamber 21, so as to prevent water and the like from coming into the connector housing 20.

Next, as shown in FIGS. 4 and 5, the front holder 30 is gradually inserted into the connector housing 20. Then, as shown in FIG. 6, when the terminal fitting 10 is completely installed in the connector housing 20, the lance deformation prevention portion 33 of the front holder 30 is inserted into the space S in the terminal accommodation chamber 21 so as to be brought into contact with the arm 23B of the locking lance 23. Accordingly, the elastic deformation of the locking lance 23 is prevented, so that the terminal fitting 10 cannot be drawn out from the connector housing 20.

When the terminal fitting 10 is completely installed in the connector housing 20, the engaged frame 31C of the front holder 30 is engaged with the engagement convex portion 24 of the connector housing 20. Accordingly, the front holder 30 is fixed to the connector housing 20, so that the front holder 30 is prevented from being detached from the connector housing 20. At this time, the packing 34 is closely attached to the inner surface of the holder accommodation chamber 22 and the outer surface of the insertion portion 31A of the holder main body 31, so as to prevent water and the like from coming into the connector housing 20.

As shown in FIG. 7, in a case where the locking projection end 23C of the locking lance 23 is not inserted into the lance insertion hole 13 of the terminal fitting 10 (that is, in a case of a half-contact state of the terminal fitting 10 and the bus bar 32), the lance deformation prevention portion 33 of the front holder 30 is abutted with the front end of the arm 23B of the locking lance 23 but not inserted into the space S in the terminal accommodation chamber 21. Accordingly, the fact that the locking projection end 23C of the locking lance 23 is not inserted into the lance insertion hole 13 of the terminal fitting 10 can be detected.

### (4) Operations and Effects

In the present embodiment described above, the lance deformation prevention portions 33 prevent the electric deformation of the locking lances 23. Accordingly, even in a case where some impact (such as vibration of a vehicle) is generated, the locking lances 23 engaged with the terminal fittings 10 are not elastically deformed, so that disengagement of the terminal fittings 10 and the locking lances 23 can be prevented. Therefore, a retaining force of the terminal fittings 10 in the connector housing 20 can be improved.

The lance deformation prevention portions 33 are inserted into the spaces in which the locking lances 23 are deflected, in the engagement state of the terminal fittings 10 and the locking lances 23. Accordingly, the front holder 30 is installed in the connector housing 20, so that the engagement state of the terminal fittings 10 and the locking lances 23 can be detected. Thus, the fact that the terminal fittings 10 are completely installed in the terminal accommodation chambers 21 can be detected. Meanwhile, the lance deformation prevention portions 33 are abutted with the locking lances in a non-engagement state of the terminal fittings 10 and the locking lances 23. Accordingly, the front holder 30 is not installed in the connector housing 20, so that the non-engagement state of the terminal fittings 10 and the locking lances can be detected. Thus, the fact that the terminal fittings 10 are not installed in the terminal accommodation chambers 21 can be detected. As a result, an installment state of the terminal fittings 10 into the terminal accommodation chambers 21 (including a half-installment state) can be detected.

Further, the bus bars 32 and the lance deformation prevention portions 33 are integrated with the holder main body 31. Accordingly, in comparison to a case where the bus bars and the lance deformation prevention portions are separate bodies, an assembling task can be reduced and manufacturing cost of the joint connector 1 can be reduced.

In the present embodiment, the packing 34 is closely attached to the inner surface of the holder accommodation chamber 22 and the outer surface of the holder main body 31. Accordingly, water and the like can be prevented from coming into the connector housing 20. Particularly, by integrating the packing 34 with the holder main body 31, in comparison to a case where the packing is a separate body, the assembling task can be reduced and the manufacturing cost of the joint connector 1 can also be reduced.

In the present embodiment, the engaged frame 31C is engaged with the engagement convex portion 24. Accordingly, the front holder 30 is fixed to the connector housing 20 and the front holder 30 can be prevented from being detached from the connector housing 20.

According to the present embodiment, the joint connector 1 capable of detecting a half-installment state of the terminal fittings 10 into the terminal accommodation chambers 21 while improving the retaining force of the terminal fittings 10 in the connector housing 20 can be provided.

### (5) Other Embodiments

As described above, the content of the present invention is disclosed through the embodiment of the present invention. However, the statement and the drawings serving as part of this disclosure do not limit the present invention. Those skilled in the art will understand various alternative embodiments, examples, and operational technologies from this disclosure.

For example, the embodiment of the present invention can be changed as follows. Specifically, although the front holder 30 includes the packing 34 in the above description, the present invention is not limited to this but the front holder does not necessarily include the packing 34.

The engagement convex portion 24 is provided on the outer surface of the connector housing 20 and the front holder 30 includes the engaged frame 31C in the above description. However, the present invention is not limited to this but this relationship may be opposite. It should be noted that the engagement convex portion 24 and the engaged frame 31C are not necessarily provided.

In such a way, the present invention includes various embodiments and the like which are not described herein as a matter of course. Therefore, the technical scope of the present invention is defined only by particular matters according to the claims corresponding to the above description.

The entire content of Japanese Patent Application No. 2011-245255, filed on Nov. 9, 2011, is herein incorporated by reference.

1. A joint connector, comprising:
a connector housing comprising terminal accommodation chambers configured to accommodate terminal fittings therein, the terminal accommodation chambers having elastically-deformable locking lances configured to engage with the corresponding terminal fittings;
bus bars configured to connect the terminal fittings to each other; and
a front holder to be installed in the connector housing from an opposite side to a side where the terminal fittings are inserted, the front holder comprising a holder main body integrated with the bus bars and lance deformation prevention portions integrated with the holder main body, the lance deformation prevention portions being configured to prevent elastic deformation of the locking lances,
wherein, in an engagement state of the terminal fittings and the locking lances, the lance deformation prevention portions are configured to be inserted into spaces in which the locking lances are deflected.

2. The joint connector according to claim 1, wherein
the connector housing comprises a holder accommodation chamber configured to accommodate the front holder therein, and
the front holder comprises a packing closely attached to an inner surface of the holder accommodation chamber and an outer surface of the holder main body.

3. The joint connector according to claim 1, wherein the holder main body comprises an engaged portion configured to be engaged with an engagement portion provided on an outer surface of the connector housing to fix the front holder to the connector housing.

4. The joint connector according to claim 2, wherein the holder main body comprises an engaged portion configured to be engaged with an engagement portion provided on an outer surface of the connector housing to fix the front holder to the connector housing.
